(19) United States
(12) Patent Application Publication
(10) Pub. No.: US 2026/0070369 A1
(43) Pub. Date: Mar. 12, 2026

(54) CRAYON CUTTER

(71) Applicant: Crayola LLC, Easton, PA (US)

(72) Inventors: Ying K. HO, Bethlehem, PA (US); Joseph MOLL, Bethlehem, PA (US); Kimyung RYU, Easton, PA (US)

(21) Appl. No.: 19/322,214

(22) Filed: Sep. 8, 2025

Related U.S. Application Data
(60) Provisional application No. 63/692,420, filed on Sep. 9, 2024.

(51) Int. Cl. B43L 23/00; B43L 23/04; B44C 5/00

(52) U.S. Cl. CPC B43L 23/008; B43L 23/04; B44C 5/00

(57) ABSTRACT

A crayon cutter having a housing and a cutter positioned in the housing. The housing defines a first opening configured to receive a crayon and a second opening. The cutter is configured for actuation to cut a portion of the crayon off of the remainder of the crayon. The cutter is positioned in the housing so that the portion of the crayon passes through the second opening after it is cut off of the remainder of the crayon.

### CROSS-REFERENCE TO RELATED APPLICATIONS

This application is based on and claims priority to U.S. Provisional Application Ser. No. 63/692,420, filed on Sep. 9, 2024, which is incorporated herein by reference in its entirety.

### BACKGROUND

Crayons are conventionally used to apply color to items or otherwise decorate items.

### SUMMARY

A crayon cutter having a housing and a cutter positioned in the housing. The housing defines a first opening configured to receive a crayon and a second opening. The cutter is configured for actuation to cut a portion of the crayon off of the remainder of the crayon. The cutter is positioned in the housing so that the portion of the crayon passes through the second opening after it is cut off of the remainder of the crayon.

In some embodiments, the cutter may be configured to shape the portion of the crayon. The cutter may be configured to shape the portion of the crayon into a spherical shaped bead.

In some embodiments, the crayon cutter may include an actuator assembly coupled to the cutter and configured to rotate the cutter.

In some embodiments, the crayon cutter may include a tray positioned adjacent the second opening and configured to receive the portion of the crayon.

In some embodiments, the cutter may be configured for actuation to cut a plurality of shavings off of the crayon as it cuts the portion of the crayon. The cutter may be positioned in the housing so that the shavings of the crayon pass through the second opening after being cut off of the remainder of the crayon.

In some embodiments, the cutter is movable between a retracted position, and an actuated position. The cutter is biased toward the crayon when in the actuated position.

In some embodiments, the cutter comprises a cylindrical side wall defining an inner cavity and teeth extending from a distal end of the side wall.

### BRIEF DESCRIPTION OF THE DRAWINGS

FIG. 1 is a perspective view of a crayon cutter in accordance with an exemplary embodiment of the invention described herein;

FIG. 2 is a rear perspective view of the crayon cutter of FIG. 1;

FIG. 3 is a perspective view of the crayon cutter of FIG. 1 with an outer housing removed;

FIG. 4 is a perspective view of the crayon cutter of FIG. 1 with the outer housing and an inner housing removed;

FIG. 5 is a perspective view of an actuator assembly of the crayon cutter of FIG. 1;

FIG. 6 is a cross-sectional view of the crayon cutter of FIG. 1 taken through a plane containing the X and Y axes shown in FIG. 4;

FIG. 7 is a perspective view of a release mechanism, pinion, and cutter of the crayon cutter of FIG. 1;

FIG. 8 is a perspective view of a portion of the outer housing of the crayon cutter of FIG. 1;

FIG. 9 is a cross-sectional view of a portion of the crayon cutter of FIG. 1 taken through a plane containing the Y and Z axes shown in FIG. 4 and showing the cutter in a released position;

FIG. 10 is a cross-sectional view similar to FIG. 9 but showing the cutter in an actuated position;

FIGS. 11A and 11B show a crayon wrapper cutter of the crayon cutter of FIG. 1;

FIG. 12 shows beads and shavings that may be created using the crayon cutter of FIG. 1 and decorative items that may be packaged as part of a kit with the crayon cutter;

FIG. 13 shows an ornament decorated with beads produced by the crayon cutter; and

FIG. 14 shows a plurality of ornaments decorated with beads produced by the crayon cutter.

### DETAILED DESCRIPTION OF EXEMPLARY EMBODIMENTS

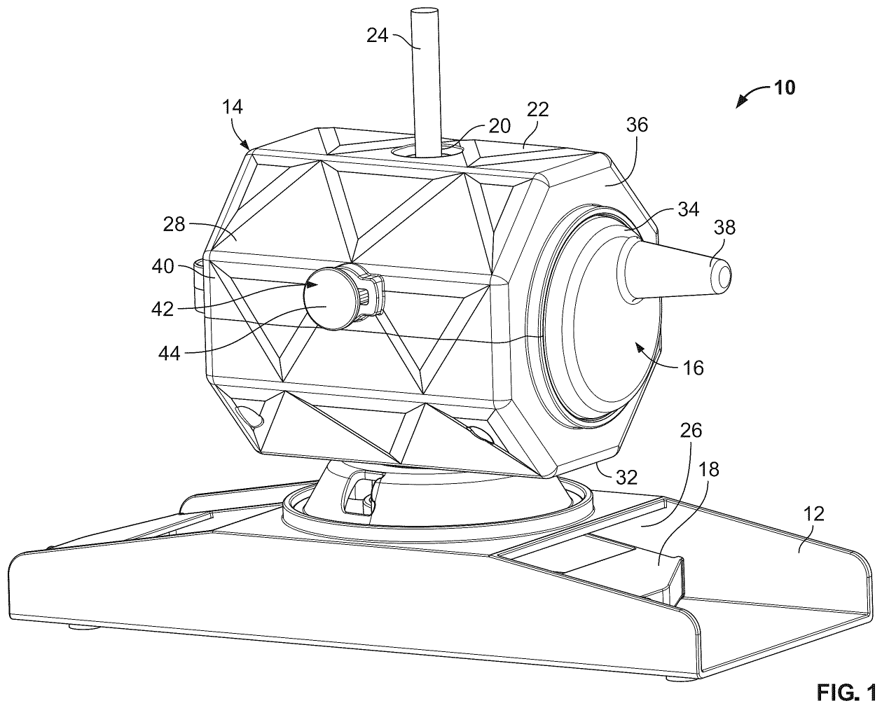

A crayon cutter in accordance with one embodiment of the invention described and claimed herein is identified generally as 10 in FIG. 1. As described in more detail below, the crayon cutter 10 is configured for use to cut portions of a crayon off of the remainder of the crayon while shaping those cut off portions into beads that may be spherical shaped or any other desired shape. Further, the crayon cutter cuts shavings off of the crayon while cutting the beads off of the remainder of the crayon. The beads and shavings may then be used to decorate items as desired.

Referring to FIG. 1, the crayon cutter 10 includes a base 12, a housing 14 mounted on the base 12, an actuator assembly 16 rotatably coupled to the housing 14, and a tray 18 slidably removable from the base 12. The housing 14 includes an opening 20 defined by an upper wall 22 of the housing 14. The opening 20 is configured for receiving a crayon 24. The base 12 includes a recess 26 positioned beneath the housing 14 within which the tray 18 may be inserted. The tray 18 is positioned underneath the housing 14 for receiving the beads and the shavings cut off of the crayon.

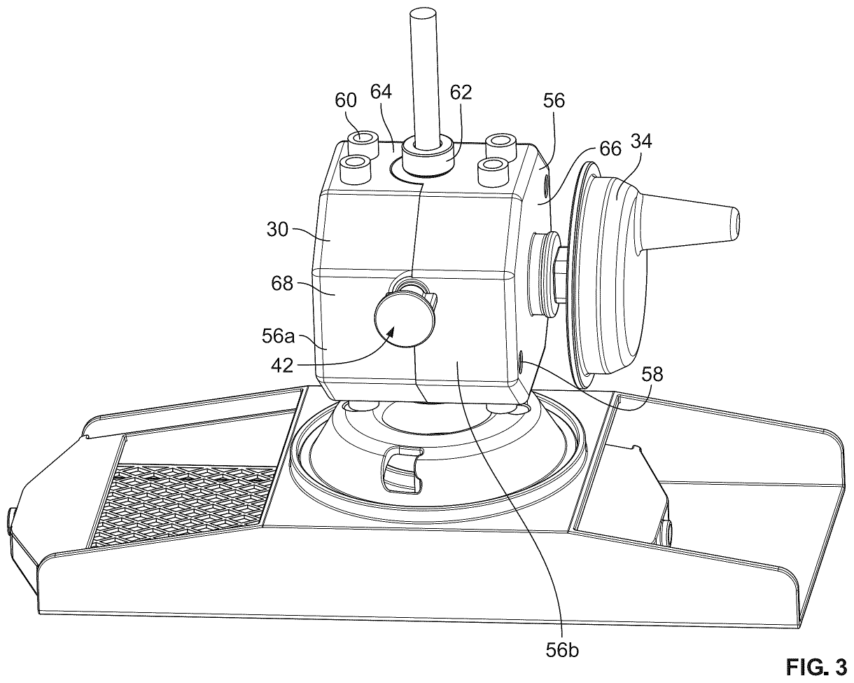

The housing 14 includes an outer housing 28, which is shown in FIG. 1, and an inner housing (or gearbox) 30, which is shown in FIG. 3. A bottom wall 32 of the outer housing 28 is supported by the base 12. The actuator assembly 16 includes a crank 34 that is rotatably mounted to a first end wall 36 of the outer housing 28. The crank 34 includes a handle 38 that may be grasped by a user for rotating the crank 34. A side wall 40 of the outer housing 28 includes an opening that slidably receives a release mechanism 42. The release mechanism 42 includes a knob 44 extending from the side wall 40, which may be grasped by a user for manipulating the release mechanism 42. While the outer housing 28 is shown with an octagonal cross-section (i.e., as an octagonal prism), the outer housing 28 may be any desired shape.

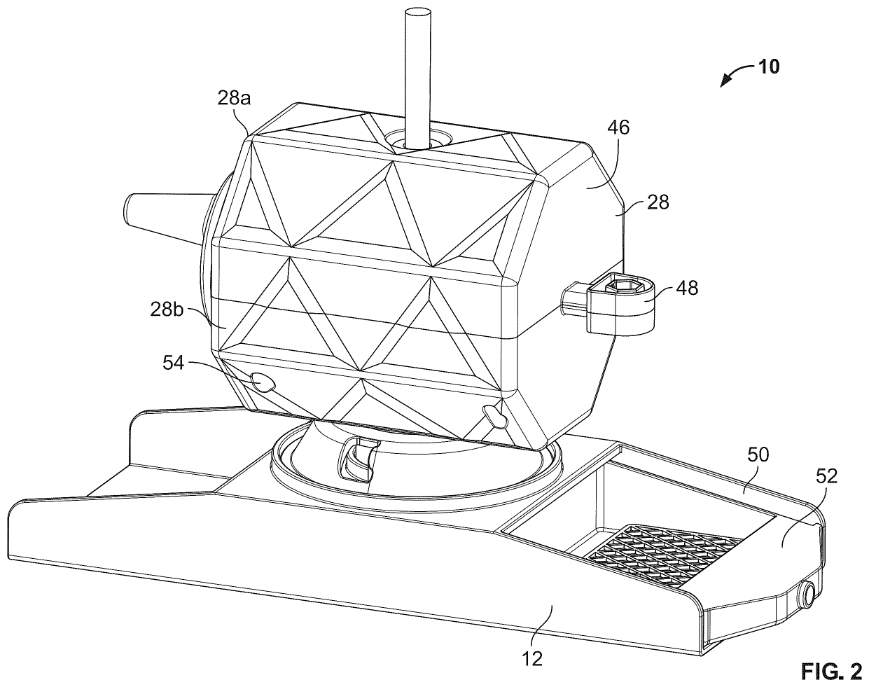

FIG. 2 shows the opposite side of the outer housing 28. A second end wall 46 of the outer housing 28 includes a slot for releasably receiving a crayon wrapper cutter 48, which is described in more detail below. The base 12 further includes a second tray recess 50 for receiving a second tray 52. The outer housing 28 includes a top half 28a and a bottom half 28b that are joined together with fasteners (not shown) inserted through openings, one of which is identified as 54, in the bottom half 28b.

FIG. 3 shows the crayon cutter 10 with the outer housing 28 removed. The housing 14 includes an inner housing 56 that is positioned within the outer housing 28. The inner housing 56 is formed from first and second halves 56a-b joined together with fasteners (not shown) inserted through openings, one of which is identified as 58. Posts (not shown) on the outer housing 28 are received within recesses, one of which is identified as 60, of the inner housing 54 to mount and position the outer housing 28 with respect to the inner housing 54.

A collar 62 is rotatably mounted to an upper wall 64 of the inner housing 54. The collar 62 has an opening for receiving the crayon 24. The crank 34 is rotatably mounted to an end wall 66 of the inner housing 54. A side wall 68 of the inner housing 54 includes an opening that slidably receives the release mechanism 42.

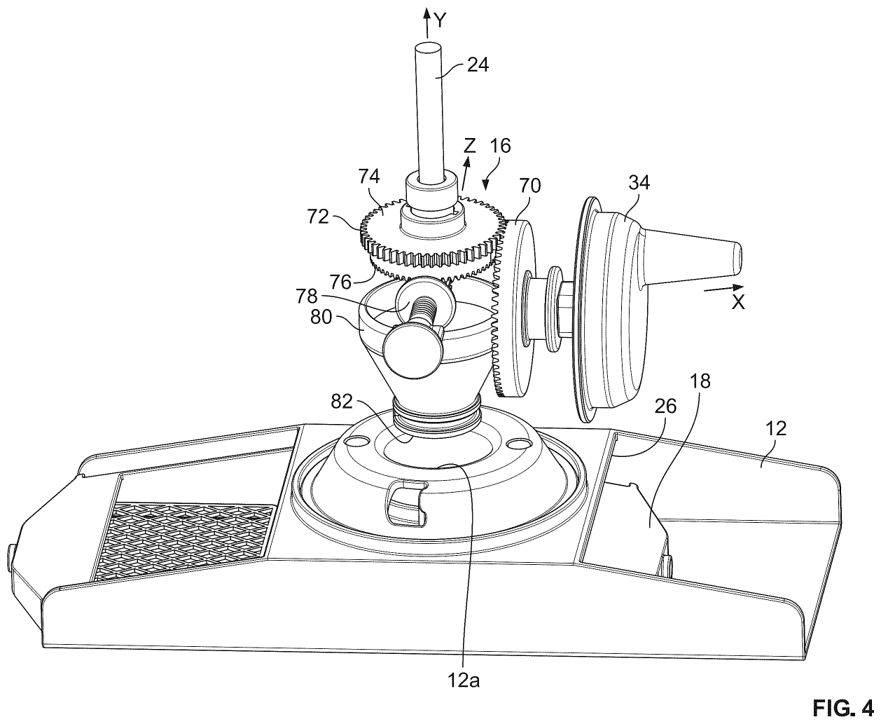

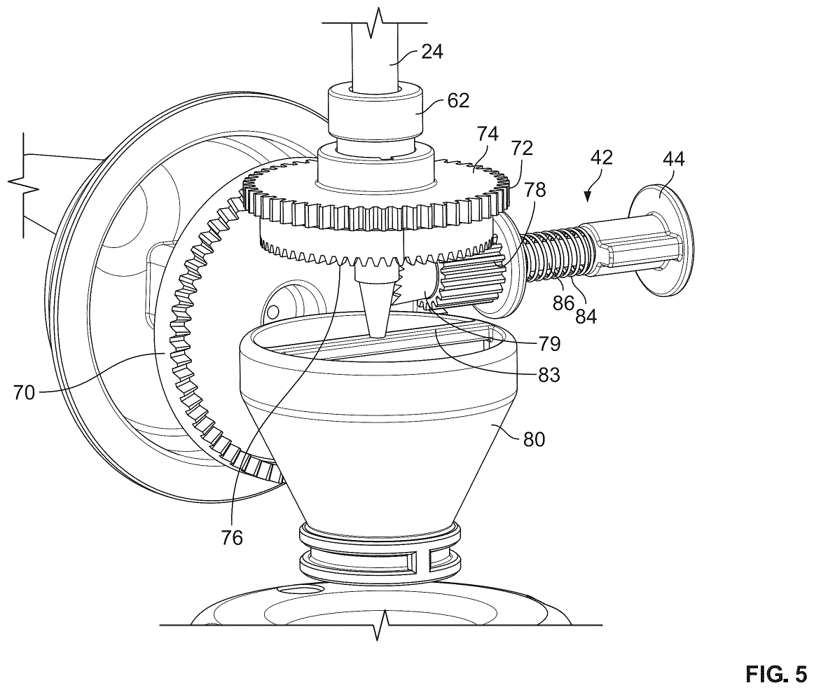

FIG. 4 shows the crayon cutter 10 with the inner housing 54 removed. The actuator assembly 16 includes a crank gear 70 that is mounted to the crank 34 so that it rotates with the crank 34. The crank gear 70 engages a first set of teeth 72 on a driven gear 74. A second set of teeth 76 on the driven gear 74 engage teeth on a pinion 78, as best shown in FIG. 5. The crank gear 70 is rotatable about an X-axis via rotation of the crank 34 by a user. The rotating crank gear 70 causes rotation of the driven gear 74 about a Y-axis. The rotating driven gear 74 causes rotation of the pinion 78 about a Z-axis.

The housing 14 further includes a funnel 80 configured to receive the beads and shavings cut off of the crayon 24. The funnel 80 has a lower opening 82 that is positioned above an opening 12a in an upper portion of the base 12. The opening 12a in the base 12 is positioned above the recess 26 so that the beads and shavings cut off of the crayon 24 can be deposited into the tray 18.

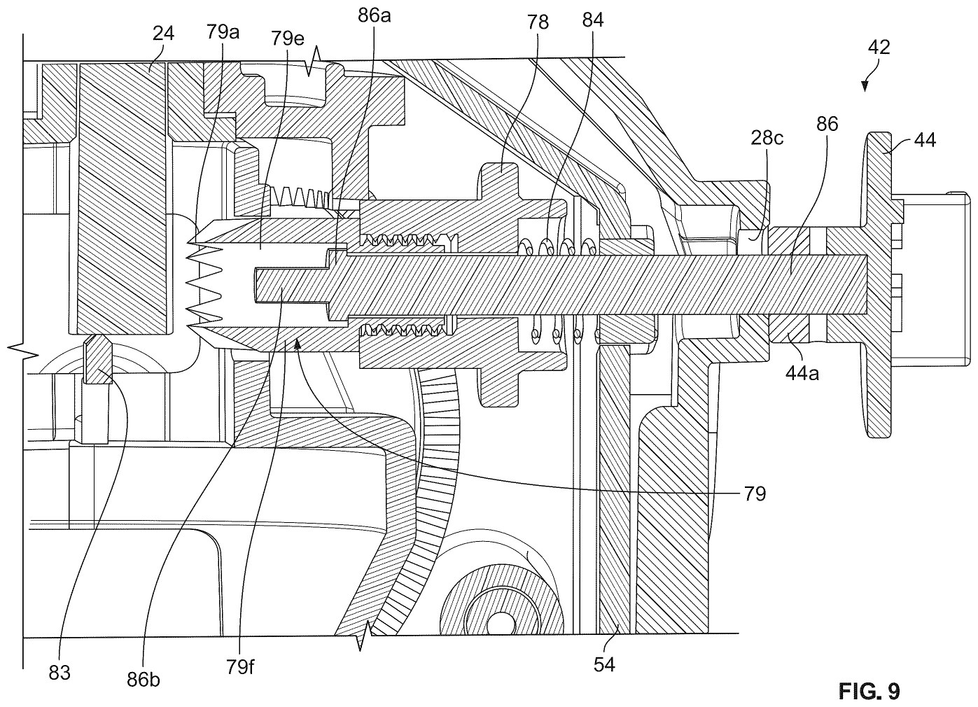

As shown in FIG. 5, the funnel 80 has a crossbar 83 on which a lower edge of the crayon 24 rests when it is inserted in the housing 14. The release mechanism 42 includes a spring 84 that biases the pinion 78 and a cutter 79 toward the crayon 24. As shown in FIG. 9, one end of the spring 84 engages an inner surface of the inner housing 54 and the opposite end of the spring 84 engages the pinion 78. A shaft 86 connected to the knob 44 and extending through the spring 84 engages the cutter 79, which is fixedly mounted on the pinion 78. Pulling on the knob 44 retracts the pinion 78 and the cutter 79 away from the crayon 24 while compressing the spring 84.

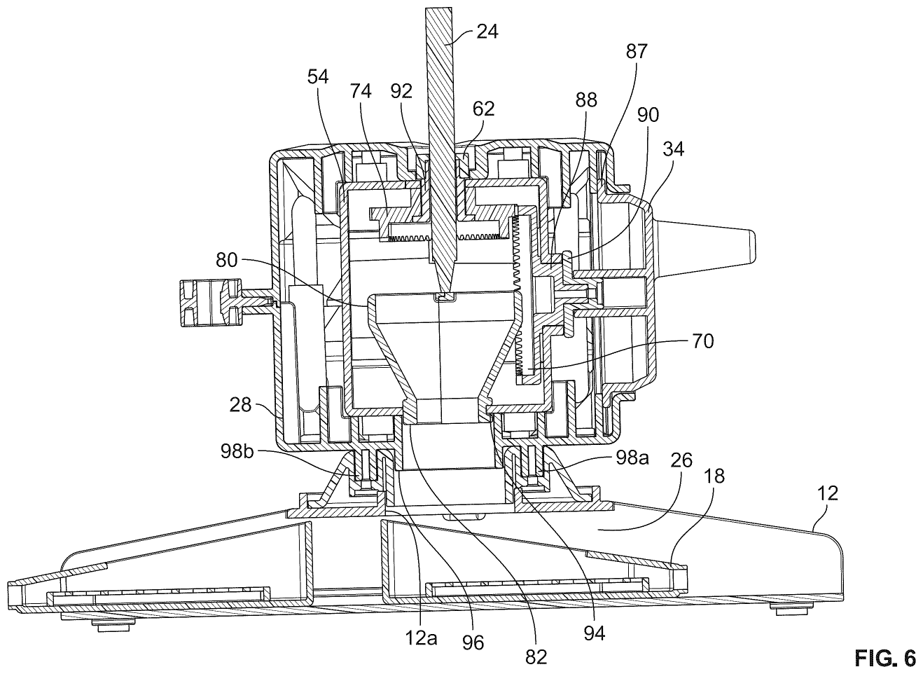

Referring to FIG. 6, the crank 34 includes a flange 87 that is rotatably mounted within an annular recess of the outer housing 28. The crank gear 70 has a protrusion 88 that extends through an opening in the inner housing 54 to rotatably mount the crank gear 70 to the inner housing 54. A cap 90 is mounted to the protrusion 88 with a fastener (not shown). The cap 90 extends into a recess on the crank 34 to mount the crank gear 70 to the crank 34. The cap 90 and recess of the crank 34 have non-circular cross-sections so that rotation of the crank 34 effects rotation of the crank gear 70.

The driven gear 74 has a central opening with a journal 92 mounted within it. The journal 92 has a central through channel that receives the crayon 24. The journal 92 frictionally engages the crayon 24 so that the crayon 24 rotates along with the driven gear 74. The journal 92 extends through an opening in the upper wall of the inner housing 54. The collar 62 is mounted on an upper end of the journal 92. The collar 62 has a diameter that is larger than the opening through the upper wall of the inner housing 54 to rotatably mount the driven gear 74 to the upper wall of the inner housing 54.

An outer wall of the funnel 80 includes a slot 94 adjacent its lower edge that receives a portion of the inner housing 54 to mount the funnel 80 to the inner housing 54. Openings 82 and 12a of the funnel 80 and base 12, respectively, are aligned with an opening 96 of the outer housing 28. The aligned openings 82, 12a, and 96 are positioned above the recess 26 of the base 12 so that cut off beads and shavings of the crayon 24 can fall into the tray 18, as described above.

Posts 98a-b on the outer housing 28 are received within recesses on the base 12 to mount the outer housing 28 to the base 12.

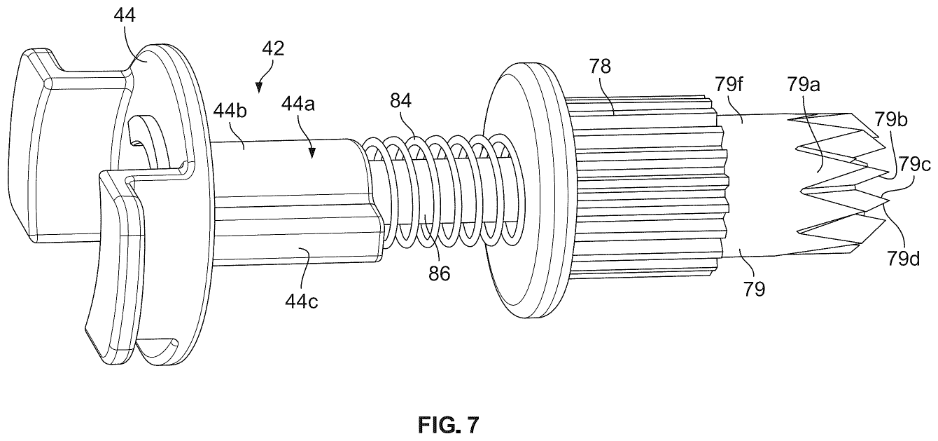

FIG. 7 shows the cutter 79 and its attachment to the pinion 78 and release mechanism 42 in more detail. The cutter 79 is fixedly attached to the pinion 78 so that the cutter 79 rotates when the pinion 78 is rotated via actuation of the crank 34. The cutter 79 is generally cylindrical and extends outward from the pinion 78. At its distal end farthest from the pinion 78, the cutter 79 includes a series of teeth, one of which is identified as 79a. The teeth 79a are circumferentially spaced from each other and extend from a distal end of a cylindrical side wall 79f. The teeth 79a have cutting edges, three of which are identified as 79b-d, that are operable to engage the crayon 24 and cut shavings off of the crayon 24 to form a bead when the cutter 79 rotates and is pressed into engagement with the crayon 24 by the spring 84. The cutting edges 79b-d are arranged at an angle with respect to a longitudinal axis passing through the center of the cutter 79 (i.e., the axis Z shown in FIG. 4). The edge 79c may engage the crayon 24 when the cutter 79 is rotated in one direction, and the edge 79b may engage the crayon 24 when the cutter 79 is rotated in the opposite direction.

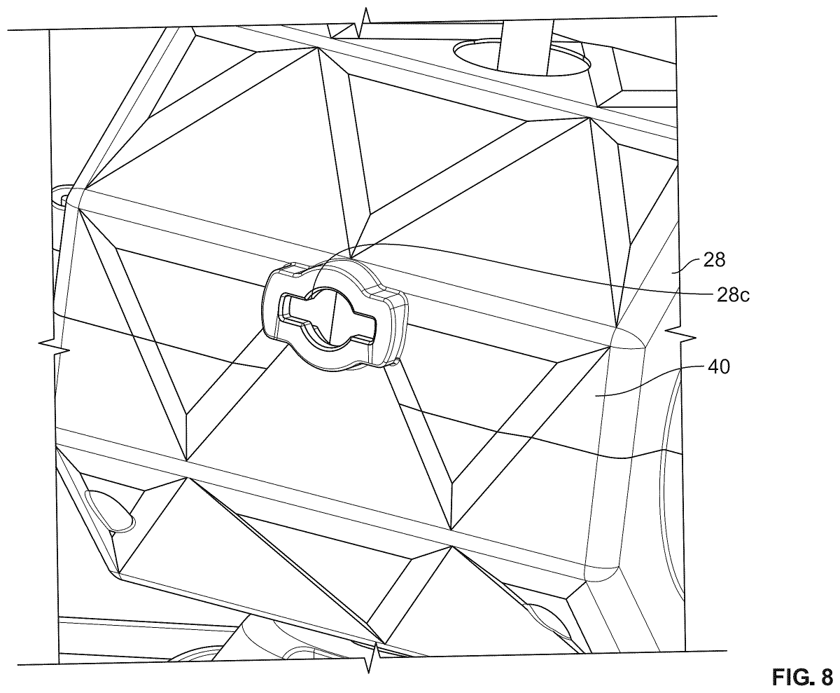

The knob 44 has a keyed section 44a extending toward the pinion 78. The keyed section 44a includes a central cylinder 44b with rectangular protrusions, one of which is shown as 44c, extending outward from opposite sides of the cylinder 44b. The protrusions 44c interact with the opening 28c of the outer housing 28, shown in FIG. 8. The opening 28c has the same shape as the keyed section 44a (i.e., it has a round central portion with two rectangular portions extending from either side of the round central portion). The opening 28c is configured to receive the keyed section 44a when the rectangular protrusions 44c of the keyed section 44a are aligned with the rectangular portions of the opening 28c.

FIG. 9 shows the release mechanism 42 and cutter 79 in a retracted position. In this position, the keyed section 44a of the knob 44 is not aligned with the opening 28c. For example, the rectangular protrusions 44c of the keyed section 44a are positioned so they do not align with the rectangular portions of the opening 28c. In this retracted position, the spring 84 is partially compressed between the pinion 78 and the inner housing 54, and the teeth 79a of the cutter 79 are spaced apart from the crayon 24.

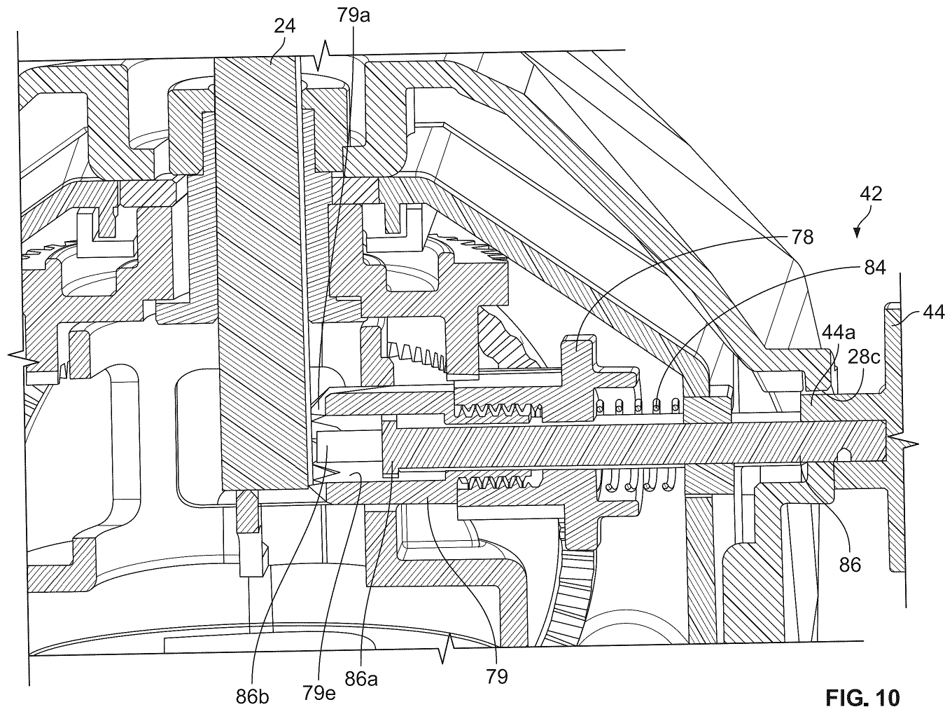

FIG. 10 shows the release mechanism 42 and cutter 79 in an actuated position. In this position, the keyed section 44a of the knob 44 is aligned with the opening 28c so that the rectangular protrusions 44c of the keyed section align with and are received by the rectangular portions of the opening 28c. Further, the spring 84 is expanded and exerting force on the pinion 78 biasing the cutter 79 toward the crayon 24 so that the teeth 79a of the cutter 79 engage the crayon 24.

The release mechanism 42 may be moved from the actuated position shown in FIG. 10 to the retracted position shown in FIG. 9 by grasping the knob 44 and pulling the knob 44 until the keyed section 44a is no longer positioned in the opening 28c. The knob 44 may then be rotated 90 degrees so that the keyed section 44a is not aligned with the opening 28c. The knob 44 may then be released so that the keyed section 44a rests on the outer surface of the outer housing 28, as shown in FIG. 9.

The knob 44 is fixedly mounted on the shaft 86 such that they move together. The shaft 86 extends through aligned openings formed in the pinion 78 and the cutter 79. At the distal end of the shaft 86 within the cutter 79, the shaft 86 has an enlarged end 86a that is larger than the opening through the cutter 79. When the release mechanism 42 is in the retracted position shown in FIG. 9, the enlarged end 86a engages an internal surface of the cutter 79 to retract the cutter 79 away from the crayon 24 and cause the pinion 78 to compress the spring 84. When the release mechanism is in the actuated position shown in FIG. 10, the enlarged end 86a is positioned inside a central cavity 79e of the cutter 79 and the cutter 79 is free to rotate with respect to the shaft 86.

As shown in FIG. 9, the cutter 79 has a central cavity 79e positioned within the cylindrical side wall 79f of the cutter 79. As the cutter 79 rotates and engages the crayon 24, the cutter slices shavings off of the crayon 24 around a portion of the crayon 24 that will eventually form the cut off bead of the crayon. The spring 84 presses the cutter 79 toward the crayon 24 so that the cutter 79 is continually advanced through the entire crayon 24. The portion of the crayon 24 that will form the bead may be received by the central cavity 79e as the cutter 79 advances through the surrounding portions of the crayon 24. After the cutter 79 advances through the entire crayon 24 to form the bead, the bead may be pushed out of the central cavity 79e by an end protrusion 86b of the shaft 86 when the release mechanism 42 is reset to the retracted position.

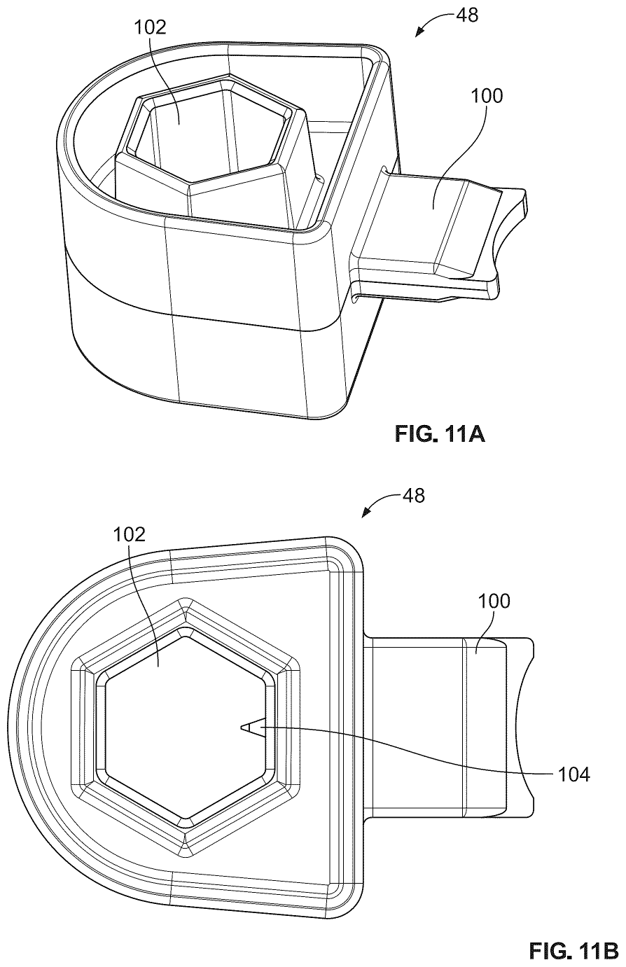

Referring to FIGS. 11A and 11B, the crayon wrapper cutter 48 includes a tab 100 for insertion into a recess on the outer housing 28, as described above, to removably mount the crayon wrapper cutter to the outer housing. A channel 102 extends through the crayon wrapper cutter 48 and is configured for receiving a crayon. A triangular protrusion 104 with a pointed edge extends into the channel 102. To remove a wrapper from a crayon, the crayon may be pushed through the channel 102. As the crayon is pushed through the channel 102, the protrusion 104 cuts through the wrapper from one end of the crayon to the opposite end of the crayon. The wrapper may then be removed from the crayon. The crayon wrapper cutter 48 may be substantially the same as the wrapper removal mechanism described in U.S. Pat. No. 9,827,618 and U.S. Pat. No. 10,780,509, each of which are hereby incorporated by reference herein.

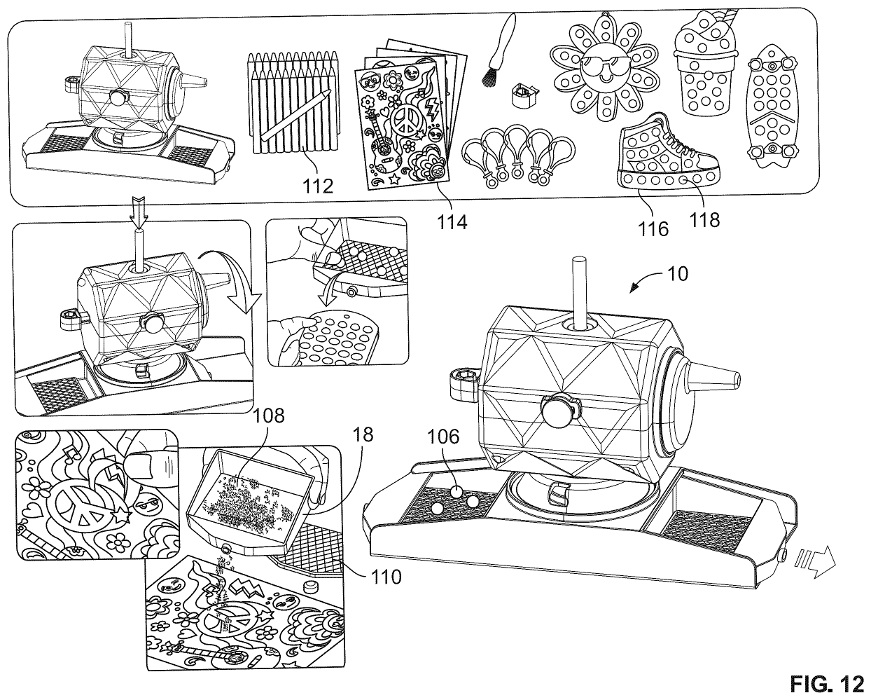

FIG. 12 shows beads 106 that may be cut off of a crayon using the crayon cutter 10. The beads 106 are shown as generally spherical, but may be any other desired shape. Shavings 108 that may be cut off of a crayon while cutting the beads 106 are also shown in FIG. 12. The tray 18 has a removable screen 110. The beads 106 may be retained on the screen 110 while the shavings 108 fall through the screen 110 to separate the shavings 108 from the beads 106. The crayon cutter 10 may be packaged as part of a kit with a set of crayons 112, sheets 114 of paper or cardstock with designs, and decorative ornaments 116. The decorative ornaments 116 include a plurality of receptacles 118 for receiving the beads 106. Adhesive may be applied to the sheets 114 and the shavings 108 may be deposited on the adhesive to decorate the sheets 114. The beads 106 and shavings 108 may further be used for any other desired purpose.

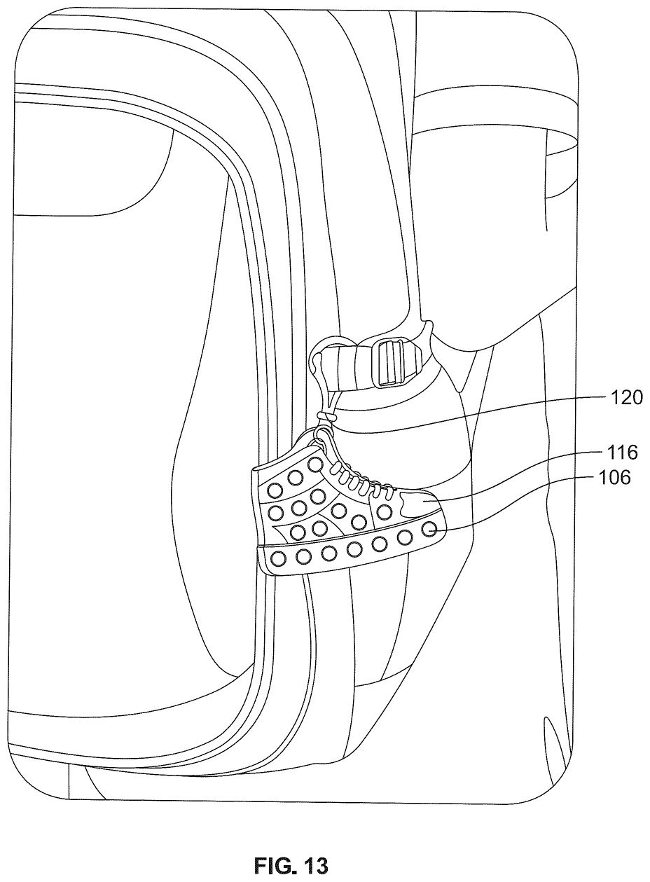

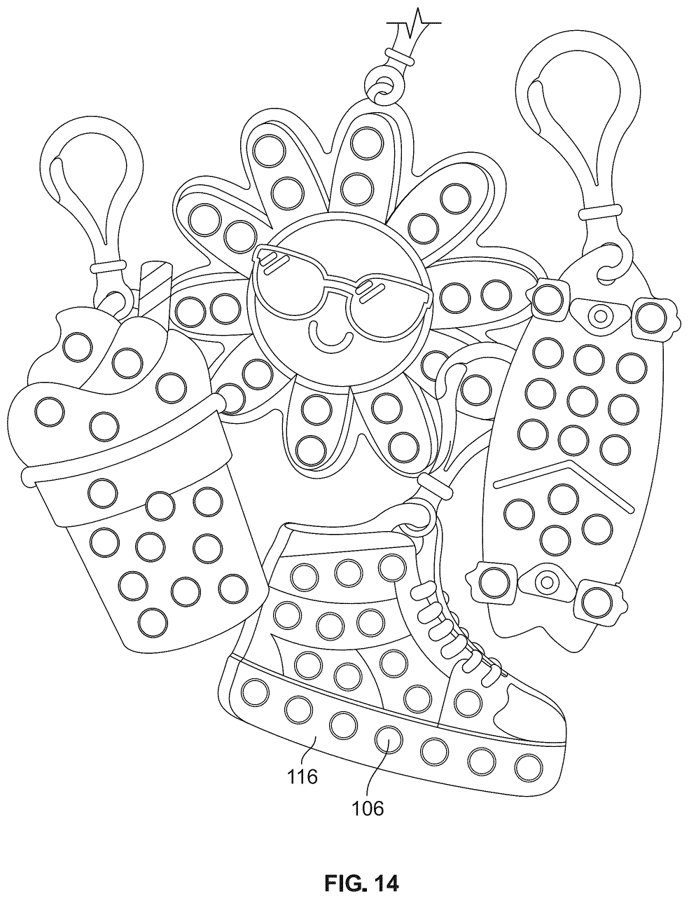

FIG. 13 shows a shoe ornament 116 with a plurality of beads 106 that may be different colors inserted into receptacles of the ornament 116. A clip 120 may be used to attach the ornament 116 to a bag or other desired article. FIG. 14 shows a plurality of the ornaments 116 with beads 106 inserted into receptacles of the ornaments 116 for decoration.

In use, a user inserts a crayon 24 into the opening 20 on top of the housing 14 and a tray 18 into the recess 26 of the base 12. The release knob 44 is pulled back to the retracted position shown in FIG. 9, and the crayon 24 is pushed through the opening 20 until the bottom of the crayon rests on the crossbar 83, as shown in FIG. 9. The release mechanism 42 is then moved to the actuated position shown in FIG. 10, as described above. The crank 34 is then rotated with the handle 38 to turn the cutter 79 and cut a bead off of the crayon 24. As the cutter 79 rotates, the crayon 24 also rotates to facilitate even cutting through and around the bead. Due to the difference in diameter of the gears 76 and 78, the crayon 24 rotates slower than the cutter 79. For example, the crayon 24 may rotate once for every three rotations of the cutter 79. To continue cutting beads off of the crayon 24, the release mechanism 42 is moved back to the retracted position shown in FIG. 9. The bead and shavings cut off of the crayon 24 fall into the tray 18. The crayon 24 may then be pushed downward until it again engages the crossbar 83. The release mechanism 42 is then moved back to the actuated position shown in FIG. 10, and the crank 34 is rotated. In some embodiments, approximately eight beads may be cut from a single crayon.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A crayon cutter comprising:
a housing defining a first opening configured to receive a crayon and a second opening; and
a cutter positioned in the housing and configured for actuation to cut a portion of the crayon off of the remainder of the crayon, wherein the cutter is positioned in the housing so that the portion of the crayon passes through the second opening after it is cut off of the remainder of the crayon.

2. The crayon cutter of claim 1, wherein the cutter is configured to shape the portion of the crayon.

3. The crayon cutter of claim 2, wherein the cutter is configured to shape the portion of the crayon into a spherical shaped bead.

4. The crayon cutter of claim 1, further comprising an actuator assembly coupled to the cutter and configured to rotate the cutter.

5. The crayon cutter of claim 4, wherein the actuator assembly comprises a crank and a plurality of gears coupled to the crank and the cutter, wherein the crank is operable to rotate the plurality of gears and the cutter.

6. The crayon cutter of claim 5, wherein one of the plurality of gears defines a third opening aligned with the first opening of the housing, the third opening configured to receive the crayon, and wherein the one of the plurality of gears defining the third opening is configured to rotate the crayon when the one of the plurality of gears rotates.

7. The crayon cutter of claim 1, further comprising a tray positioned adjacent the second opening and configured to receive the portion of the crayon.

8. The crayon cutter of claim 1, wherein the cutter is configured for actuation to cut a plurality of shavings off of the crayon as it cuts the portion of the crayon, wherein the cutter is positioned in the housing so that the shavings of the crayon pass through the second opening after being cut off of the remainder of the crayon.

9. The crayon cutter of claim 1, wherein the cutter is movable between a retracted position, and an actuated position, wherein the cutter is biased toward the crayon when in the actuated position.

10. The crayon cutter of claim 9, further comprising a release mechanism configured to move the cutter between the retracted position and the actuated position.

11. The crayon cutter of claim 10, wherein the release mechanism comprises a knob with a keyed section and a shaft that extends through a third opening of the housing, wherein the third opening is configured to receive the keyed section when the cutter is in the actuated position, and wherein the keyed section engages an outer surface of the housing when the cutter is in the retracted position.

12. The crayon cutter of claim 11, wherein a spring positioned between the housing and the cutter biases the cutter toward the crayon when the cutter is in the actuated position.

13. The crayon cutter of claim 12, wherein the shaft extends through an opening of the cutter, wherein a distal end of the shaft has an enlarged end that is larger than the opening of the cutter, and wherein the enlarged end is operable to engage the cutter and move it from the actuated position to the retracted position.

14. The crayon cutter of claim 1, wherein the cutter comprises a cylindrical side wall defining an inner cavity and teeth extending from a distal end of the side wall.
